(19) United States
(12) Patent Application Publication
(10) Pub. No.: US 2014/0278687 A1
(43) Pub. Date: Sep. 18, 2014

(54) System and Method for Optimizing A Demand Response Event

(71) Applicant: GRIDGLO LLC, Delray Beach, FL (US)

(72) Inventors: Katie McConky, Lockport, NY (US); Richard Viens, Gulf Stream, FL (US)

(73) Assignee: GRIDGLO LLC, Delray Beach, FL (US)

(21) Appl. No.: 13/833,815

(22) Filed: Mar. 15, 2013

(51) Int. Cl. G06Q 10/06

(52) U.S. Cl. CPC G06Q 10/06312
USPC 705/7.22

(57) ABSTRACT

A system and method is disclosed for optimizing a demand response event. Strategizes for demand response events developed according to the present disclosure consider a customer's individual satisfaction ranking in creating a customer-specific demand response participation schedule so that customer dissatisfaction is reduced and a more uniform customer response across the entire demand response event is achieved. Customers participating in a demand response event need not participate in the entire event and can limit their participation to coincide with their individual satisfaction ranking.

### BACKGROUND

Demand response is used by utilities to influence the amount of electricity a given customer, or end user, is using at a certain point in time with the intent for the end user to use less electricity than they normally would use. Utilities use demand response for a variety of reasons including emergency power management, avoiding brownouts on peak usage days, delaying the building of a new power plant by curbing peak usage, and to meet peak demands with lower generation costs. Demand response systems have been implemented in a variety of manners, with the two main differentiators being incentive based systems and time and price based systems. With incentive based systems the utility may have direct control over an end user's electricity usage or the utility may send out requests for demand response events the day prior to an event execution, and the end user is responsible for reducing their demand during the event time period. With the former scenario, when utilities have direct control over the end user's demand, high drop-out rates have led utilities to be reluctant to execute their demand response capabilities.

Embodiments of the present disclosure address these high dropout rates by seeking to maximize customer satisfaction while still meeting utility demand response goals. With price based systems utilities can influence end user demand response by varying the price of electricity. In some instances customers have devices in their homes, such as programmable thermostats, that directly respond to price signals issued by the utility. In other price based instances the price varies predictably by time of day thereby influencing customers to shift their usage of electricity to off peak hours.

Accordingly, there is a need for optimizing demand response events to take into account customers' individual satisfaction ranking so that customer dissatisfaction is reduced and a more uniform customer response across the entire demand response event is achieved.

### BRIEF DESCRIPTION OF THE DRAWINGS

FIG. 1 is a high level flow chart for a demand response optimization process according to an embodiment of the present subject matter.

FIG. 2 is a diagram of notional customer participation levels for a demand event according to an embodiment of the present subject matter.

FIG. 3 is a graph of a customer satisfaction curve for a demand event according to an embodiment of the present subject matter.

FIG. 4 is a table presenting exemplary customer participation schedules for a demand event according to an embodiment of the present subject matter.

FIG. 5 is a flow chart for a demand response optimization process according to another embodiment of the present subject matter.

FIG. 6 is a flow chart for an expanded demand response optimization process, according to an embodiment of the present subject matter.

FIG. 7 is a flow chart for another expanded demand response optimization process, according to another embodiment of the present subject matter.

FIG. 8 is a flow chart for another expanded demand response optimization process, according to yet another embodiment of the present subject matter.

FIG. 9 is a flow chart for another expanded demand response optimization process, according to still another embodiment of the present subject matter.

FIG. 10 is a block diagram of a system for optimizing a demand response event according to an embodiment of the present subject matter.

FIG. 11 is a block diagram of a system for optimizing a demand response event according to another embodiment of the present subject matter.

### DETAILED DESCRIPTION

With reference to the figures where like elements have been given like numerical designations to facilitate an understanding of the present subject matter, various embodiments of a system and method for compensating for timing misalignments are described. In order to more fully understand the present subject matter, a brief description of applicable circuitry will be helpful.

Embodiments of the present disclosure provide improvements to existing demand response strategies by considering a customer's satisfaction with regards to individual demand response events and creating a customer specific demand response participation schedule. The novel system and method seeks to minimize customer dissatisfaction while meeting utility demand response goals with uniform response across the entire demand response event. Embodiments of the present disclosure work with both incentive based and price based demand response implementations. An embodiment includes the aspect of flexible participation in a demand response event by the customers where the customers need not participate in the demand response event to the same degree or follow the same participation schedule for a single event.

With attention drawn to FIG. 1, a high level flow chart for a demand response optimization process 100 is depicted according to an embodiment of the present subject matter. The optimization process 100 includes a series of input parameters 110. The more detailed and accurate the input parameters 110 are to the optimization process 100, the better the overall optimization process will function, but the optimization process can still function with missing input parameters, albeit at a sub-optimal level. In an embodiment, the input parameters 110, which are described in further detail below, feed selectively into two separate modules/processes/components, a customer event forecasting module 120 and a customer satisfaction ranking module 130. The function of the customer event forecasting module 120 is to forecast the potential load shed of each customer during a demand response event, while the customer satisfaction ranking module 130 functions to provide an estimate of a customer's satisfaction level with regards to participating in a certain demand response event. The customers' satisfaction levels along with their individual event forecasts are then input to the optimized customer selection module 140. The optimized customer selection module 140 produces a participation schedule 150 which is input to an entity's demand response event execution module 160, for example, a utility's demand response event execution system. The performance of each customer during the demand response event is then analyzed in the demand response performance analyzer module 170 and fed back into the optimization process as an input for future demand response events.

Input parameters 110 include a variety of parameters and information that may be used as input to the demand response optimization process 100. Input parameters 110 may be selectively used by the customer event forecast module 120 and/or the customer satisfaction ranking module 130. In an embodiment, a key aspect of the optimization process 100 is the focus on individual satisfaction of each customer. Part of the optimization process includes, at module 101, the ability for customers to define one or more levels of participation. In a simplistic, non-limiting case, only one level of participation may apply to all customers participating in a demand response event. In a more complex, non-limiting case, each customer individually customizes both the number of commitment levels of participation and the actions the customer will take at each demand response event commitment level. With the ability to choose the number of and customization of each of one or more levels of demand response participation, the likelihood that a customer will feel more comfortable participating in the demand response event increases. Additionally, in an embodiment, each customer has the ability to set their own “satisfaction level” which corresponds to the demand response participation level at which the customer would be happy to participate under any, or a wide range of, circumstances.

Now turning to FIG. 2, a diagram is presented of notional customer participation levels for a demand response event according to an embodiment of the present subject matter. In this non-limiting example, Customer 1 has set three participation levels: for Level 1 at block 211, Customer 1 will raise or lower his thermostat by one degree (depending on the season); for Level 2 at block 212, Customer 1 will raise or lower his thermostat by four degrees (depending on the season) as well as curtail his pool pump; and for Level 3 at block 213, Customer 1 will raise or lower his thermostat by four degrees (depending on the season), curtail his pool pump, and reduce the load drawn by his refrigerator. Additionally, Customer 1 has set a satisfaction level 215 at Level 1. The satisfaction level indicates the level at which Customer 1 will be happy to participate in a demand response event. Beyond Level 1, Customer 1 becomes inconvenienced to some extent and thus contributes to the system wide dissatisfaction level.

Further in this non-limiting example, Customer 2 has set four participation levels: for Level 1 at block 221, Customer 2 will curtail his pool pump; for Level 2 at block 222, Customer 2 will curtail his pool pump and raise or lower his thermostat by two degrees (depending on the season); for Level 3 at block 223, Customer 2 will limit his use of his cooking stove, raise or lower his thermostat by five degrees (depending on the season), and curtail his pool pump; and for Level 4 at block 224, Customer 2 will curtail his pool pump, raise or lower his thermostat by six degrees (depending on the season), limit his use of his electric stove, reduce the load drawn by his refrigerator, and decrease the energy use of his charging electric vehicle. Additionally, Customer 2 has set a satisfaction level 225 at Level 2. The satisfaction level indicates the level at which Customer 2 will be happy to participate in a demand response event. Beyond Level 2, Customer 2 becomes inconvenienced to some extent and thus contributes to the system wide dissatisfaction level. Those of skill in the art will readily understand that the present disclosure contemplates more and varied participation levels by customers above those given in this non-limiting example.

In embodiments where demand response is controlled via dynamic pricing or time of use based pricing, customer's participation levels will typically correspond to different pricing thresholds. While embodiments of the disclosed demand response optimization process are designed to be flexible enough to handle one or more participation levels from a customer, other embodiments do not require predefined participation levels.

At module 102, external customer attributes may be brought into the demand response optimization process 100 to assist, in an embodiment, in the customer satisfaction ranking process 130, as will be discussed in more detail below. External customer attributes 102 may include, but are not limited to, attributes related to the structure of the physical premises of a customer, attributes related to the demographics of the customer, and attributes related to the financial state of the customer.

At module 103, customer historical consumption data may be brought into the demand response optimization process 100 for use with, in an embodiment, one or both of the customer event forecasting process 120 and/or the customer satisfaction ranking process 130, as will be discussed in more detail below. Historical consumption data for a customer may be in the form of interval kWh usage data in 15 minute, hourly, daily, or other frequency intervals.

At module 104, customer historical demand response performance data may be brought into the demand response optimization process 100 for use with, in an embodiment, one or both of the customer event forecasting process 120 and/or the customer satisfaction ranking process 130, as will be discussed in more detail below. Data items evaluated in customer historical demand response performance data may include, but are not limited to, kWh reduction during each segment of a demand response event, demand response reduction profile (i.e., how did a customer's demand response load reduction decline throughout a demand response event), customer's rebound effect after the demand response event, customer's demand response event dropout rates, customer's demand response event performance to forecast, and overall demand response event participation by the customer.

At module 105, customer demand response contract information may be brought into the demand response optimization process 100 for use with, in an embodiment, one or both of the customer event forecasting process 120 and/or the customer satisfaction ranking process 130, as will be discussed in more detail below. In an embodiment, the customer demand response contract information includes the terms of a demand response program for which the customer signed up to participate. As is known in the art, demand response contracts may be different from customer to customer. In an embodiment, the demand response contract information contains not only the agreement between the customer and an entity, such as a utility, but also any contract related information with respect to the current demand response state of the customer. For example, if the contract states that a customer can only participate in a maximum of 15 events per year, the demand response contract information may also provide the number of demand response events in which the customer has participated that year, to date. The demand response contract information may include, but is not limited to, the following items: limitations on the number of events per year a customer is required to participate in a demand response event, limitations on the number of kWh per year for which the customer can be incentivized, limitations on the number of kWh per year the customer can be requested to curtail, time of day constraints for when demand response events can take place, day of the week constraints for when demand response events can take place, day of the year constraints for when demand response events can take place, incentive information for load reduction by the customer, costs associated with demand response event price based plans, and most recent demand response event participation by the customer.

At module 106, demand response event parameter data may be brought into the demand response optimization process 100 for use with, in an embodiment, one or both of the customer event forecasting process 120 and/or the customer satisfaction ranking process 130, as will be discussed in more detail below. In an embodiment, demand response event parameter data 106 may be used as an input to the optimized customer selection module 140. In an embodiment, demand response event parameter data includes the day of the requested demand response event, the hours of the requested demand response event, and the total system wide kWh reduction required for a successful demand response event.

In an embodiment, the customer event forecast module 120 creates a forecast for each level of participation for which the customer may be asked to participate, as well as for each possible demand response event participation window, as discussed below.

As a non-limiting example, a typical demand response event may include only a single participation window, whereby each customer participating in the demand response event is required to participate for the entire demand response event duration. In embodiments using this single participation window example, customer event forecast module 120 will generate, for each participation level of the customer, a forecast for the entire demand response event duration. In other embodiments, however, the demand response event may be divided up into multiple participation windows, such that a customer may be asked, or elect, to only participate during a portion of the demand response event. In this case, where a demand response event has multiple participation windows, the customer event forecast module 120 will generate, for each customer, multiple forecasts, one for each participation level for each of the possible event participation windows. However, any particular customer is not required to participate for the entire duration of a demand response event. A demand response event forecast is thus computed for each customer for each possible participation level for which the customer may participate. Each of these forecasts includes the anticipated kWh reduction by the customer during a single demand response event base unit, where a base unit may be any length of time, for example, one hour.

In an embodiment, the customer event forecast module 120 may take into consideration one or more of the following: the demand response event parameters, specifically the duration and time of the event, local weather, forecasted usage for no event participation, past demand response performance, typical rebound effect observed for the customer or similar customers, and the decline in performance typically observed throughout the duration of a demand response event.

The set of potential demand response forecasts for each customer are used within the optimized customer selection module 140 to select and schedule customer participation for the demand response event.

As a non-limiting example for creating a demand response event forecast, an initial step includes forecasting the usage of the customer during the demand response event period as if no demand response event were taking place. For this a linear regression model approach may be used to forecast a customer's usage per hour with a certain set of predicted weather attributes. A single hourly prediction may take the form:

$$predicted hourly kWh = {c}_{1 HD} + {c}_{2 HD} ( hourlyLowTemp ) + {c}_{3 HD} ( hourlyHighTemp ) + {c}_{4 HD} ( avgHourlyTemp ) + {c}_{5 HD} ( avgCloudCover ) + {c}_{6 HD} ( avgHumidity ) + {C}_{7 HD} ( minutesSun ) + {c}_{8 HD} ( season ) + {{c}_{9 HD} ( hourlyLowTemp )}^{2} + {{c}_{10 HD} ( hourlyHighTemp )}^{2} + {{c}_{11 HD} ( avgHourlyTemp )}^{2}$$

where c_{1HD}-c_{11HD} are the coefficients learned for each hour of the day H, for each day of the week D from a set of training data, using a standard linear regression approach.

The actual event forecast may then be created from the base hourly forecast by augmenting the base hourly forecast in the following manner:

$$event forecast ( hour i , level l ) = {predictedHourlykWh}_{ i} - {DRkWhReduction}_{ i , l} + {reboundAffect}_{ i , l} + {DRkWhPerformanceLoss}_{ i , l}$$

Where the DRkWhReduction_{i,l} is the anticipated kWh load reduction obtained by the customer at hour i of Level 1 participation. The DRkWhReduction_{i,l} is learned from historical participation data, where available, and/or estimated by the characteristics of the participation levels committed to by the customer. The reboundAffect_{i,l} is the amount of load increase that can be anticipated after a customer has finished participating in a demand response event participation window. The reboundAffect_{i,l} may be zero if the customer is participating during the participation window. Finally, the DRkWhPerformanceLoss_{i,l} is the decrease in load reduction expected for each hour of participation in the demand response event. Both the reboundAffect_{i,l} and DRkWhPerformanceLoss_{i,l} may be estimated from historical performance data.

In an embodiment, the customer satisfaction ranking module 130 creates a customer satisfaction ranking which is a number that indicates the relative satisfaction of an individual customer while participating in an event compared to other potential demand response event participants. A customer satisfaction ranking will be created for a customer for each participation window of the demand response event. A number of attributes may be used to define the customer satisfaction ranking and may include, but are not limited to, attributes related to customer historical demand response performance (block 104), customer historical consumption data (block 103), external customer attributes (block 102), and demand response event parameters (block 106). In an embodiment, particular attributes related to customer historical demand response event performance (block 104) that may be included in a customer satisfaction ranking include, but are not limited to, past customer event participation or demand response event dropout rates, past demand response event effort such as total reduction versus predicted reduction, the extent of the demand response taper (i.e., how quickly a customer's reduction tapered off as the demand response event proceeded), the number of events the customer has previously participated in, and the date of the most recent customer participation in a demand response event.

In an embodiment, particular attributes related to customer historical consumption data (block 103) include, but are not limited to, the forecast usage by the customer during the demand response event (to estimate the impact the demand response event will have on the customer), the efficiency of the customer's household (e.g., such as the energy efficiency to estimate how long it will take for the customer's house to warm up/cool off), and the predictability of the customer. In an embodiment, particular attributes related to customer external attributes (block 102) include, but are not limited to, attributes related to the structure of the physical premises of a customer, attributes related to the demographics of the customer, and attributes related to the financial state of the customer. Non-limiting examples include age of customer's premises occupants, age of the customer's premises structure, energy generation capabilities at the customer's site, the presence of a pool, and tree coverage. Demand response event parameters (block 106) may also have a significant effect on customer satisfaction, and in an embodiment these parameters may include, but are not limited to, factors such as the length and start time of the demand response event and the weather at the customer's location during the demand response event. The output of the customer satisfaction ranking module 130 may be validated during an ongoing process that will measure event participation rates and program dropout rates for the customer compared to an initial baseline value.

As a non-limiting example, the customer satisfaction ranking module 130 may include an Analytic Hierarchy Process (“AHP”). The AHP is used to weight attributes related to customer satisfaction in a controlled and logical manner. The AHP creates attribute weights based on pairwise attribute comparisons. The attribute comparisons are used to evaluate the relative importance of one attribute over another attribute with respect to evaluating customer satisfaction. The attribute weights are then used to create a linear combination of attribute values to create the final satisfaction score. To put all attributes on the same playing field for combination, attributes undergo a transformation process to a 0 to 1 scale. Table 1, below, contains a sample AHP matrix that contains 5 exemplary attributes. Those of skill in the art will readily understand that the current disclosure is not limited to these exemplary attributes. Table 1 may be interpreted as follows: occupant age is considered to have the same importance as at home during the day, while the setting of the thermostat is considered to be much less important (five times less important in Table 1) than being at home during the day.

TABLE 1
Sample AHP Matrix

| | At Home | | | | Num Of |
|---|---|---|---|---|---|
| | During | Occupant | Thermostat | House | Past |
| | Day | Age | AC Temp | Age | Events |
| At Home | 1.00 | 1.00 | 5.00 | 9.00 | 0.20 |
| During Day | | | | | |
| Occupant Age | 1.00 | 1.00 | 5.00 | 9.00 | 1.00 |
| Thermostat | 0.20 | 0.20 | 1.00 | 5.00 | 0.33 |
| AC Temp | | | | | |
| House Age | 0.11 | 0.11 | 0.20 | 1.00 | 0.33 |
| Num Of Past | 5.00 | 1.00 | 3.00 | 3.00 | 1.00 |
| Events | | | | | |

Table 2, below, provides a description of the meaning of the AHP matrix entries. The eigenvector of the resultant AHP matrix is used for the attribute weights in the final ranking algorithm.

TABLE 2
Sample AHP Comparison Values

| Intensity of | | |
|---|---|---|
| importance | Definition | Explanation |
| 1 | Equal importance | Two factors contribute equally to the objective |
| 3 | Somewhat more | Experience and judgement slightly favour one over |
| | important | the other. |
| 5 | Much more | Experience and judgement strongly favour one over |
| | important | the other. |
| 7 | Very much more | Experience and judgement very strongly favour one |
| | important | over the other. Its importance is demonstrated in |
| | | practice. |
| 9 | Absolutely more | The evidence favouring one over he other is of the |
| | important. | highest possible validity. |
| 2, 4, 6, 8 | Intermediate | When compromise is needed |
| | values | |

In an embodiment, the optimized customer selection module 140 maximizes customer satisfaction (or, conversely, minimizes customer dissatisfaction) with participating in a demand response event while simultaneously meeting the demand response event goals and demand response contact level constraints. The optimized customer selection module 140 may include a mathematical integer programming model and solved using heuristic methods.

The optimized customer selection module 140 creates two outputs. The primary output is the optimized participation schedule 150 for each customer which is discussed in further detail below. The secondary output is a customer satisfaction curve, such as is shown in FIG. 3. FIG. 3 illustrates a graph 300 of a customer satisfaction curve for a demand event according to an embodiment of the present subject matter. The customer satisfaction curve plots customer satisfaction (vertical axis) versus system kWh obtained for an event (horizontal axis). The customer satisfaction curve may be used to identify a kWh system threshold, i.e., a point after which system wide customer satisfaction begins to drop precipitously, such as at dotted line 301. The customer satisfaction curve may be used to provide feedback to demand response event planning software, processes, modules, or personnel for revising demand response event requests in order to improve customer satisfaction. For example, in FIG. 3 indicates that from a customer satisfaction perspective it would be much more prudent to run the demand response event at a level corresponding to dotted line 301 than at dotted line 302, even though the kWh obtained from the demand response event at dotted line 301 is lower than the kWh obtained at dotted line 302, since at 302 there is a significant loss in customer satisfaction as compared to 301.

In an embodiment, the participation schedule 150 is output from the optimized customer selection module 140. The participation schedule 150 includes a schedule of participation in a demand response event for each customer selected for the demand response event and for each participation window. As discussed above, each customer need not participate in each participation window. A non-limiting, exemplary participation schedule is shown in FIG. 4. Those of skill in the art will readily understand that the current disclosure is not limited to the simplistic exemplary participation schedule shown in FIG. 4.

FIG. 4 provides an exemplary participation schedule for a single demand response event with three participation windows. Note that Customer 1 is required to participate during all three participation windows while Customer 2 is only required to participate during the third participation window. Also note that each customer's participation levels for a given participation window are independent from one another. As can be seen from FIG. 4, each selected customer may be asked, or elect, to participate at a different level of participation for the demand response event, and the participation schedule 150 may allow for participation for a particular customer in multiple participation windows for a single demand response event, such that all customers need not participate for the entirety of the demand response event. This type of participation schedule has the ability to maintain consistent load reduction across the course of a demand response event, and can minimize the rebound effect often seen after a demand response event.

In an embodiment, the demand response optimization process 100 transmits to the demand response event execution module 160, which may be a utility's demand response execution system, the participation schedule 150. This transmission may be by any known methods. In an embodiment, the utility's demand response execution system corresponds, by known methods, with the customers to inform the customers of the operational parameters of the demand response event. The message received by the customer will differ based on the type of demand response event program run by the utility. In incentive based programs, the customer will receive, or an appliance at the customer's premises will receive, a message indicating what level of participation is required by the customer at a certain point in time. The messages may be delivered in real time, or may be delivered in advance of the event so the customer can prepare accordingly. The customer may respond to the participation level requirements manually by adjusting energy consuming appliances by hand, or the customer may have an automated system in place that responds to the requested participation level in a pre-programmed manner.

In price based programs, the message received by the customer will typically be one relating to the current price of electricity. The customer may respond to a price increase manually by adjusting energy consuming appliances, or the customer may have an automated system in place that responds to a price increase in a pre-programmed manner.

In an embodiment, the demand response optimization process 100 includes a feedback mechanism, such as the demand response performance analyzer 170, which analyzes performance to predictions for individual customers and for the system as a whole for the demand response event. The demand response performance analyzer 170 may collect statistics including customer participation rates, customer complaints, and customer drop-out rates. These may be collected post event. In an embodiment, the output of the demand response performance analyzer 170 is used as an input to trigger updates to the customer event forecast module 120 based on event observations.

Considering FIG. 5, a flow chart is shown for a demand response optimization process 500 according to another embodiment of the present subject matter. At block 520, a customer event forecast for each customer of a group of customers is determined using a first processor. At block 530, a customer satisfaction ranking for each customer of the group of customers is determined using the first processor. At block 540, a subgroup of customers is selected, using the first processor, from the group of customers based at least in part on the determined customer event forecast and the determined customer satisfaction ranking. At block 550, for each customer in the subgroup of customers a participation schedule for the demand response event is determined using the first processor. At block 551, a first predicted performance metric for the demand response event for one of the customers in the subgroup of customers is calculated, using the first processor, based at least in part on the participation schedule for the one customer in the subgroup of customers. At block 555, the participation schedule for each customer in the subgroup of customers is transmitted to an entity.

FIG. 6 displays a flow chart for an expanded demand response optimization process 600, according to an embodiment of the present subject matter. Blocks 520 through 555 are as described above for FIG. 5. At block 669, data from the demand response event is received from the entity. At block 670, a first actual performance metric is calculated, using a second processor, from the data for the one customer in the group of customers. At block 671, the first actual performance metric is compared, using the second processor, to the first predicted performance metric. In an embodiment, the first and second processors are the same.

FIG. 7 depicts a flow chart for another expanded demand response optimization process 700, according to another embodiment of the present subject matter. Blocks 520 through 551 and block 555 are as described above for FIG. 5. At block 752, a second predicted performance metric for the demand response event is calculated, using the first processor, based at least in part on an aggregation of predicted performance metrics for each one of a second subgroup of customers in the group of customers.

Now considering FIG. 8, a flow chart for another expanded demand response optimization process 800 is illustrated, according to yet another embodiment of the present subject matter. Blocks 520 through 551 and block 555 are as described above for FIG. 5. Block 752 is as described above for FIG. 7. At block 869, data from the demand response event is received from the entity. At block 870, a second actual performance metric for the data is calculated, using the second processor, based at least in part on an aggregation of actual performance metrics for said each one of a second plurality of customers in the group of customers. At block 871, the second actual performance metric is compare, using the second processor, to the second predicted performance metric. In an embodiment, the first and second processors are the same.

With attention now drawn to FIG. 9, a flow chart for another expanded demand response optimization process 900 is presented, according to still another embodiment of the present subject matter. Blocks 520 through 551 and block 555 are as described above for FIG. 5. At block 956, an aggregate customer satisfaction curve for the customers in the subgroup of customers is determined using the first processor. At block 957, a target demand response request is determined, using the first processor, based at least in part on the aggregate customer satisfaction curve.

In an embodiment, the customer event forecast is determined based on an attribute selected from the group consisting of: customer defined participation levels, customer historical consumption data, customer historical demand response performance, customer demand response contract information, demand response event parameters, and combinations thereof.

In another embodiment, the customer satisfaction ranking is determined based on an attribute selected from the group consisting of: customer defined participation levels, external customer attributes, customer historical consumption data, customer historical demand response performance, demand response event parameters, and combinations thereof.

In yet another embodiment, the participation schedule comprises more than one participation window, and each customer in the subgroup of customers is scheduled to participate in the demand response event for at least one of the more than one participation windows.

In still another embodiment, a first number of participation windows scheduled for a first customer in the subgroup of customers is different than a second number of participation windows scheduled for a second customer in the subgroup of customers.

In yet still another embodiment; the customer event forecast includes a first collection of customer-defined participation levels for a first customer and a second collection of customer-defined participation levels for a second customer.

In a further embodiment, a customer-defined participation level from the first customer is different than a corresponding customer-defined participation level from the second customer.

In yet a further embodiment, the first collection of customer-defined participation levels for the first customer includes a first satisfaction level selected by the first customer.

In still a further embodiment, the second plurality of customer-defined participation levels for the second customer includes a second satisfaction level selected by the second customer which is different than the first satisfaction level selected by the first customer.

In yet still a further embodiment, the customer satisfaction ranking includes a first assemblage of customer-defined participation levels for a first customer and a second assemblage of customer-defined participation levels for a second customer.

In an even further embodiment, a customer-defined participation level from the first customer is different than a corresponding customer-defined participation level from the second customer.

In yet an even further embodiment, the first plurality of customer-defined participation levels for the first customer includes a first satisfaction level selected by the first customer.

In still an even further embodiment, the second plurality of customer-defined participation levels for the second customer includes a second satisfaction level selected by the second customer which is different than the first satisfaction level selected by the first customer.

FIG. 10 illustrates a block diagram of a system 1000 for optimizing a demand response event according to an embodiment of the present subject matter. In an embodiment, the system 1000 includes a memory device 1001 for storing customer information and for storing parameters for the demand response event. The system 1000 further includes a first processor 1002 which may be used to: determine a customer event forecast for each of a group of customers; determine a customer satisfaction ranking for each of the group of customers; select a subgroup of customers from the group of customers based at least in part on the determined customer event forecast and the determined customer satisfaction ranking; determine for each customer in the subgroup of customers a participation schedule for the demand response event; and calculate a first predicted performance metric for the demand response event for one of the customers in the subgroup of customers, based at least in part on the participation schedule for the one customer in the subgroup of customers. The system 1000 also includes a transmitter 1003 for transmitting to an entity 1004 the participation schedule for each customer in the subgroup of customers.

In a further embodiment, system 1000 additionally includes a receiver 1005 for receiving from the entity 1004 data from the demand response event, and a second processor 1006 for calculating a first actual performance metric from the data for the one customer in the group of customers and for comparing the first actual performance metric to the first predicted performance metric. In a still further embodiment, illustrated in FIG. 11, the transmitter 1003 and the receiver 1005 in FIG. 10 are incorporated into a single transceiver device 1103, and the first processor 1002 and the second processor 1006 are incorporated into the same device, processor 1102.

In an embodiment, the present disclosure includes a machine-readable medium having stored thereon a plurality of executable instructions to be executed by a processor, the plurality of executable instructions comprising instructions to: determine a customer event forecast for each of a plurality of customers; determine a customer satisfaction ranking for each of the plurality of customers; select a group of customers from the plurality of customers, wherein the selecting is based at least in part on the determined customer event forecast and the determined customer satisfaction ranking; determine for each customer in the group of customers a participation schedule for the demand response event; calculate a first predicted performance metric for the demand response event for one of the customers in the group of customers, wherein the first predicted performance metric is based at least in part on the participation schedule for the one customer in the group of customers; and transmit to the entity the participation schedule for each customer in the group of customers.

While some embodiments of the present subject matter have been described, it is to be understood that the embodiments described are illustrative only and that the scope of the invention is to be defined solely by the appended claims when accorded a full range of equivalence, many variations and modifications naturally occurring to those of skill in the art from a perusal hereof.

We claim:

1. A method for optimizing a demand response event of an entity, the method comprising the steps of:
(a) determining, using a first processor, a customer event forecast for each customer of a plurality of customers;
(b) determining, using the first processor, a customer satisfaction ranking for each customer of the plurality of customers;
(c) selecting, using the first processor, a group of customers from the plurality of customers, wherein the selecting is based at least in part on the determined customer event forecast and the determined customer satisfaction ranking;
(d) determining, using the first processor, for each customer in the group of customers a participation schedule for the demand response event;
(e) calculating, using the first processor, a first predicted performance metric for the demand response event for one of the customers in the group of customers, wherein the first predicted performance metric is based at least in part on the participation schedule for the one customer in the group of customers; and
(f) transmitting to the entity the participation schedule for each customer in the group of customers.

2. The method of claim 1 further comprising the steps of:
(g) receiving from the entity data from the demand response event;
(h) calculating, using a second processor, a first actual performance metric from the data for the one customer in the group of customers; and
(i) comparing, using the second processor, the first actual performance metric to the first predicted performance metric.

3. The method of claim 2 wherein said first processor and said second processor are the same.

4. The method of claim 1 further comprising the step of:
(g) calculating, using the first processor, a second predicted performance metric for the demand response event, wherein the second predicted performance metric is based at least in part on an aggregation of predicted performance metrics for each one of a second plurality of customers in the group of customers.

5. The method of claim 4 further comprising the steps of:
(g) receiving from the entity data from the demand response event;
(h) calculating, using a second processor, a second actual performance metric for the data, wherein the second actual performance metric is based at least in part on an aggregation of actual performance metrics for said each one of a plurality of customers in the group of customers; and
(i) comparing, using the second processor, the second actual performance metric to the second predicted performance metric.

6. The method of claim 5 wherein said first processor and said second processor are the same.

7. The method of claim 1 further comprising the steps of:
(g) determining, using the first processor, an aggregate customer satisfaction curve for the customers in the group of customers; and
(h) determining, using the first processor, a target demand response request based at least in part on the aggregate customer satisfaction curve.

8. The method of claim 1 wherein the customer event forecast is determined based on an attribute selected from the group consisting of: customer defined participation levels, customer historical consumption data, customer historical demand response performance, customer demand response contract information, demand response event parameters, and combinations thereof.

9. The method of claim 1 wherein the customer satisfaction ranking is determined based on an attribute selected from the group consisting of: customer defined participation levels, external customer attributes, customer historical consumption data, customer historical demand response performance, demand response event parameters, and combinations thereof.

10. The method of claim 1 wherein the participation schedule comprises a plurality of participation windows, and wherein said each customer in the group of customers is scheduled to participate in the demand response event for at least one of said plurality of participation windows.

11. The method of claim 10 wherein a first number of participation windows scheduled for a first customer in the group of customers is different than a second number of participation windows scheduled for a second customer in the group of customers.

12. The method of claim 1 wherein the customer event forecast includes a first plurality of customer-defined participation levels for a first customer and a second plurality of customer-defined participation levels for a second customer.

13. The method of claim 12 wherein a customer-defined participation level from the first customer is different than a corresponding customer-defined participation level from the second customer.

14. The method of claim 12 wherein the first plurality of customer-defined participation levels for the first customer includes a first satisfaction level selected by the first customer.

15. The method of claim 14 wherein the second plurality of customer-defined participation levels for the second customer includes a second satisfaction level selected by the second customer which is different than the first satisfaction level selected by the first customer.

16. The method of claim 1 wherein the customer satisfaction ranking includes a first plurality of customer-defined participation levels for a first customer and a second plurality of customer-defined participation levels for a second customer.

17. The method of claim 16 wherein a customer-defined participation level from the first customer is different than a corresponding customer-defined participation level from the second customer.

18. The method of claim 16 wherein the first plurality of customer-defined participation levels for the first customer includes a first satisfaction level selected by the first customer.

19. The method of claim 18 wherein the second plurality of customer-defined participation levels for the second customer includes a second satisfaction level selected by the second customer which is different than the first satisfaction level selected by the first customer.

20. A system for optimizing a demand response event of an entity, the system comprising:
a memory device for storing customer information and for storing parameters for the demand response event;
a first processor for determining a customer event forecast for each of a plurality of customers;
said first processor for determining a customer satisfaction ranking for each of the plurality of customers;
said first processor for selecting a group of customers from the plurality of customers, wherein the selecting is based at least in part on the determined customer event forecast and the determined customer satisfaction ranking;
said first processor for determining for each customer in the group of customers a participation schedule for the demand response event;
said first processor for calculating a first predicted performance metric for the demand response event for one of the customers in the group of customers, wherein the first predicted performance metric is based at least in part on the participation schedule for the one customer in the group of customers; and
a transmitter for transmitting to the entity the participation schedule for each customer in the group of customers.

21. The system of claim 20 further comprising:
a receiver for receiving from the entity data from the demand response event;
a second processor for calculating a first actual performance metric from the data for the one customer in the group of customers; and
said second processor for comparing the first actual performance metric to the first predicted performance metric.

22. The system of claim 21 wherein said transmitter and said receiver are incorporated into a single transceiver device, and wherein said first processor and said second processor are the same.

23. A machine-readable medium having stored thereon a plurality of executable instructions to be executed by a processor, the plurality of executable instructions comprising instructions to:
(a) determine a customer event forecast for each of a plurality of customers;
(b) determine a customer satisfaction ranking for each of the plurality of customers;
(c) select a group of customers from the plurality of customers, wherein the selecting is based at least in part on the determined customer event forecast and the determined customer satisfaction ranking;
(d) determine for each customer in the group of customers a participation schedule for the demand response event;
(e) calculate a first predicted performance metric for the demand response event for one of the customers in the group of customers, wherein the first predicted performance metric is based at least in part on the participation schedule for the one customer in the group of customers; and
(f) transmit to the entity the participation schedule for each customer in the group of customers.
